(19) United States
(12) Patent Application Publication
(10) Pub. No.: US 2008/0222515 A1
(43) Pub. Date: Sep. 11, 2008

(54) PARAMETERIZED TYPES AND ELEMENTS IN XML SCHEMA

(75) Inventor: Steven Patterson Burns, Redmond, WA (US)

Correspondence Address: SENNIGER POWERS LLP (MSFT), ONE METROPOLITAN SQUARE, 16TH FLOOR, ST. LOUIS, MO, 63102, US

(73) Assignee: MICROSOFT CORPORATION, Redmond, WA (US)

(21) Appl. No.: 11/678,936

(22) Filed: Feb. 26, 2007

(51) Int. Cl. G06F 17/21

(52) U.S. Cl. 715/236

(57) ABSTRACT

Associating schema elements or types declared in an XML document with elements declared in another XML document. An annotation schema is defined in a first document. At least a portion of the schema declared in the original document is identified in the annotation schema of the first document. Usage properties in the annotation schema are declared for the identified portion of the schema in the original document. The declared usage properties provide additional utilities of the identified portion of the schema. The usage properties are mapped to the identified portion of the schema, and annotation data is specified in a second document based on the defined annotation schema. The specified annotation applies usages of the schema characteristics according to the usage properties.

### BACKGROUND

One of the versatile uses of extensible markup language (XML) is the ability to associate XML Schema Language or XML Schema Definition (XSD) with an XML document. An XML schema defines a structure of an XML document. For example, an XML schema provides descriptions and definitions for data types and elements in the schema. In addition, the XML schema is extensible and can be associated with other schemas or documents. For example, an XML schema can be reused by other schemas or one may also create one's own data types derived from the standard types or reference multiple schemas in the same document.

In reusing a data type or an element defined in the XML schema, current practices define a “composition” for using an element defined by the XML schema. In reusing the data types, the XML Schema Language provides an additional mechanism called derivation. The derivation in XML Schema further includes two separate uses: (1) “extension” of the type or (2) “restriction” of the type. Suppose a data type has defined “personal information” to include data for “first name” and “last name.” The extension in XML schema allows the data type “personal information” to be extended to include “address,” “city,” or “country”. On the other hand, the “restriction” of the “personal information” may be a limitation on the number of characters in the “first name” data.

Because of the current limitation of either “extension” or “restriction,” the XML schema language is unable to provide additional and convenient means to re-use a previously defined data type, such as to associate a previously defined data type with a different type or data than what was originally envisioned or defined. In addition, elements in XML schema are limited to be reused by composition.

Existing practices of creating relationships to associate different data types involve structurally encoding the relationships as properties of the related types, or as new types created specifically to represent the relationship. The first method is intrusive in that the encoded relationship affects the shape and structure of the data. The second method is unwieldy and leads to a proliferation of types that of themselves too restrictive to the specific relationship. For elements, XML schema offers no means of associating the element with other types or elements.

### SUMMARY

Embodiments of the invention provide association of a type or an element with additional metadata without altering the existing or original schema for the type or element. In addition, aspects of the invention further provide the association of a type or an element with additional types or elements without altering the existing or original schema for the type or element. Alternative embodiments of the invention create an “out-of-line” or parameterized schema in a separate XML document while establishing the relationship without overburdening the need to continue updating or modifying the existing schemas to accommodate or adapt to different data types or elements.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1A is a diagram illustrating existing practice of in-line declarations in an XML schema using an annotation mechanism in XML schema language to augment a type or an element.

FIG. 1B is a block diagram illustrating an implementation of the annotation element in an XML schema to augment the schema for a type called “CustomerType”.

FIGS. 2A to 2D are diagrams illustrating operations of associating one schema in one XML document with another schema in another XML document according to an embodiment of the invention.

FIG. 3 is a block diagram illustrating a data structure for storing data fields for associating one schema in one XML document with another schema in another XML document according to an embodiment of the invention.

FIG. 4 is a block diagram illustrating an exemplary computer-readable medium on which aspects of the invention may be stored.

Corresponding reference characters indicate corresponding parts throughout the drawings.

### DETAILED DESCRIPTION

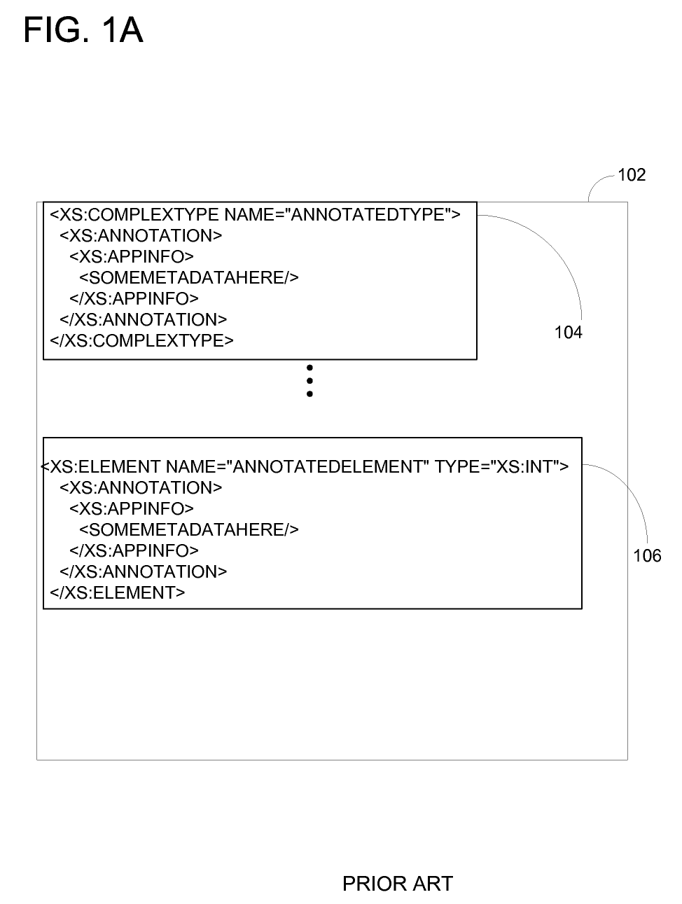

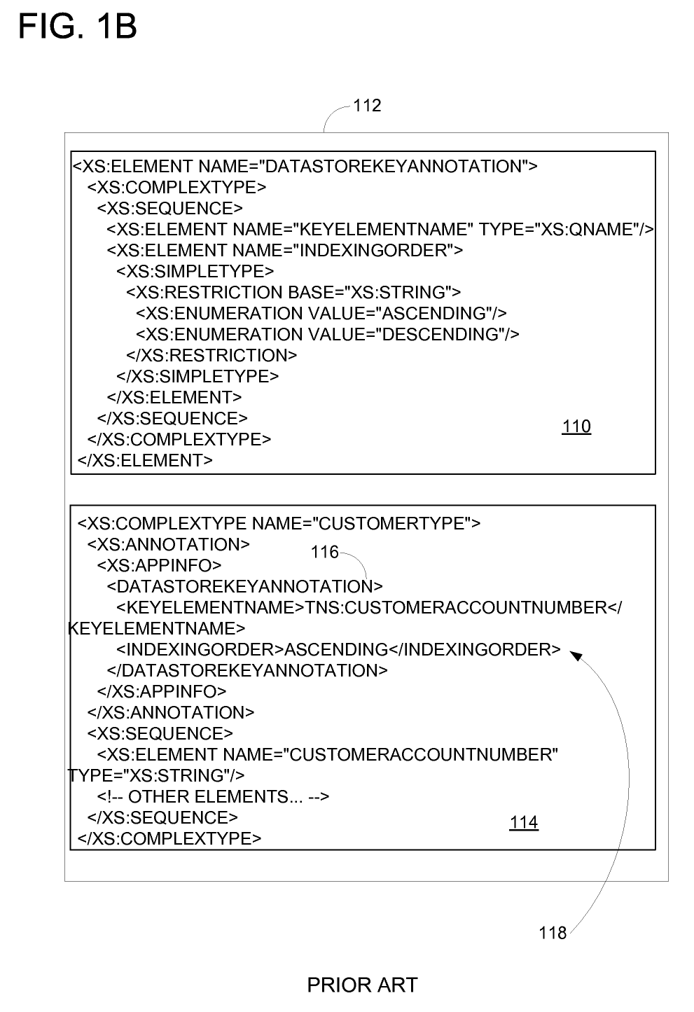

Embodiments of the invention enhance the re-usability and extensibility of a given XML schema by providing an “out-of-line” parameterization or annotation to the given schema in a separate document. For example, FIG. 1A is a diagram illustrating existing practice of in-line declarations in an XML schema using an annotation mechanism in XML schema language to augment a type or an element. FIG. 1A illustrates an exemplary block diagram showing a simplified XML document 102 with two XML schemas, namely, schema 104 and schema 106. The schema 104 illustrates an exemplary declaration of a complex data type with the name “AnnotatedType,” while the schema 106 illustrates an exemplary declaration of an element “AnonotatedElement.” In one embodiment, a type or data type is a declaration in XML Schema of the structure and constraints on XML content. The type is encoded in an XML Schema with the xs:complexType or xs:simpleType constructs and specifications. The type in XML schema may be extended or restricted with the usual XML Schema mechanisms. On the other hand, an element is a declaration in an XML Schema of the structure and constraints on XML content. As shown in the schema 106, the element is encoded in an XML Schema with the xs:element construct. The element, such as the schema 106, however, may not be extended or restricted with the usual XML Schema mechanisms.

In order to re-use the already declared type or element, FIG. 1B illustrates a simplistic example showing an implementation of the annotation element in an XML schema to augment the schema for a type called CustomerType. The schema 110 includes an annotation declaration “DataStoreKeyAnnotation,” and the declaration “DataStoreKeyAnnotation” is used to annotate the type “CustomerType”. The restriction part of “DataStoreKeyAnnotation” indicates that the content at 118 may be only “Ascending” or “Descending”.

The above existing practice in FIG. 1A requires that the use of an in-line mechanism to augment an existing type or element, but such augmentation is limited to “restriction” or “extension,” the schemas in the current XML schema specification require that the reference or association between the two schemas need to be made in the same XML document. Such limitation profoundly creates heavy burden on developers who regularly updates or creates new uses of a previously declared schema element or type. Using the schema 114 as an example. Suppose a developer A first decides to list the data in an ascending order. For examine, the developer A wishes to use the “CustomerType” in schema 114 in a database with ascending indexing order. To accomplish this goal, the developer A adds the annotation (e.g., using the XML tag <xs: annotation>) to the “CustomerType” in-line, as shown in the schema 114.

However, a second developer B would also like to use the type “CustomerType” in the same schema 114 as well. However, he wishes to use it in a database with a descending indexing order. If the developer B modifies the schema 114, the developer A's use of the “CustomerType” in the ascending order would be not be accomplished. Hence, under the existing mechanism of “annotation,” the second developer B not only needs to alter the content of the schema 114 by modifying “ascending” to “descending,” the second developer B also needs to update the version information of the XML document in lieu of this modification due to the version number change. In addition, the second developer B also needs to maintain the proper dependency by updating other XML documents that depend from or refer to the XML document prior to the modification.

As such, embodiments of the invention streamline and ease the reusability of XML schemas by creating a mechanism using an “out-of-line” or external schema to conveniently associate one schema in one XML document with another schema in another XML document. As such, by using an “out-of-line” or external mechanism in combination with XML schema, in the example above, the developer A can use the “CustomerType” defined in the schema 114 in one database with an ascending order while the developer B can use the same “CustomerType” defined in the schema 114 in another database with a descending order without altering the “CustomerType” definition in the schema 114. It is to be understood that embodiments of the invention may be applied to other definitions of data types, elements, attributes, or other characteristics in other markup-based language or expressions without departing from the scope of the invention.

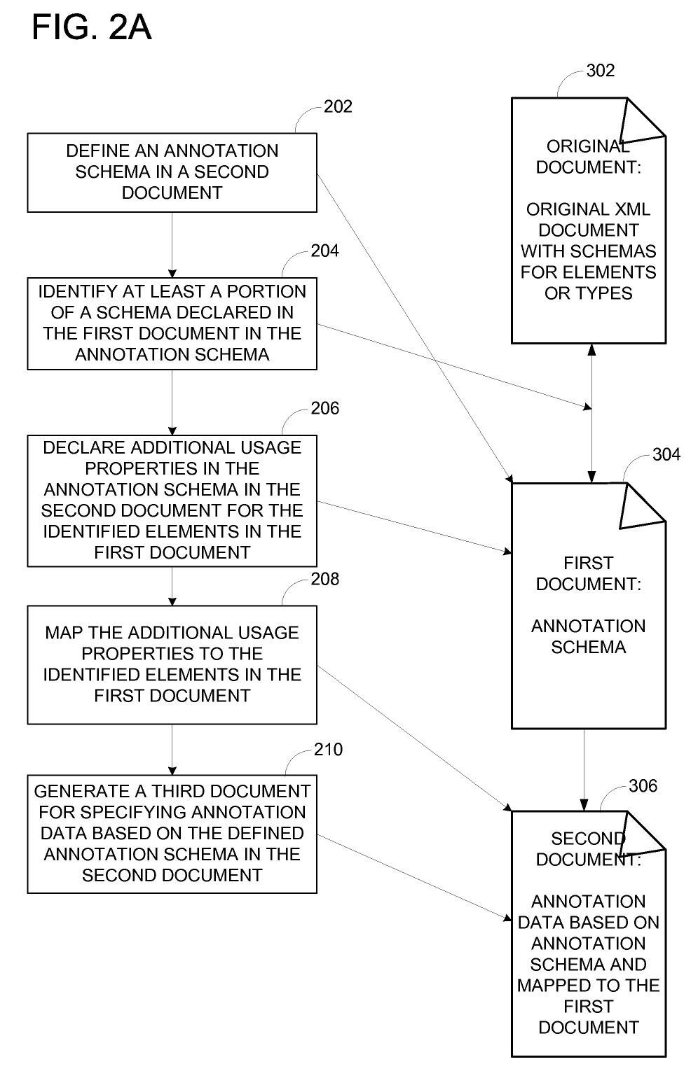

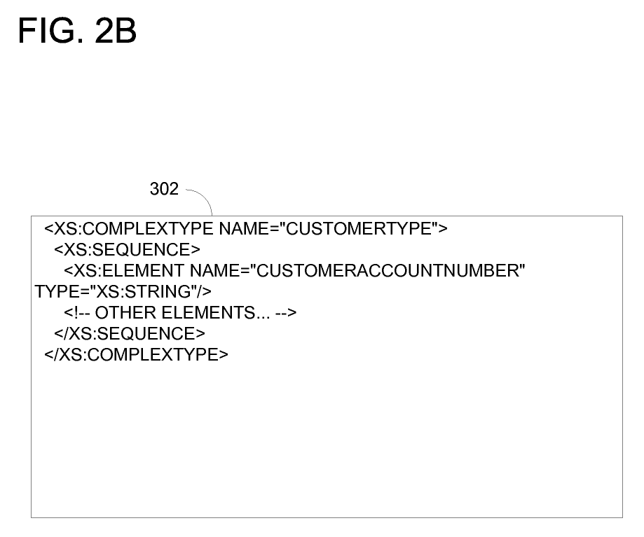

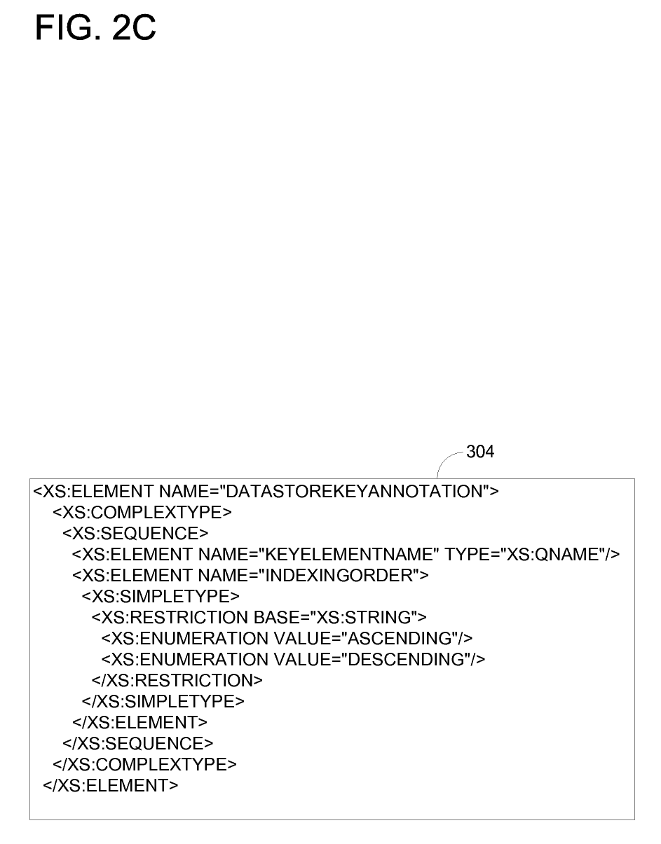

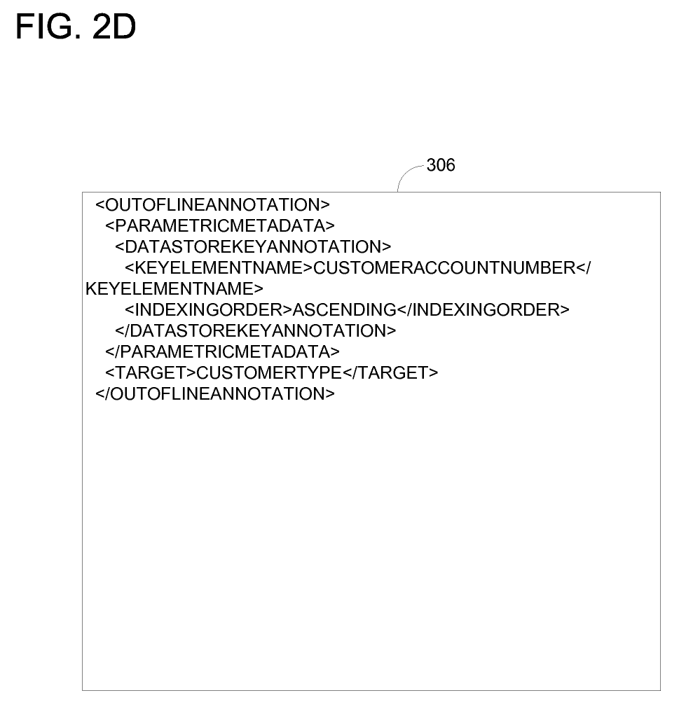

Referring now to FIGS. 2A to 2D, diagrams illustrating operations for associating a first schema in a first XML document with a second schema in a second XML document according to an embodiment of the invention. Initially, suppose an original XML document 302 includes an original schema as described in FIG. 2B. For example and not by limitation, the original document 302 declares a schema for a “CustomerType” data type in FIG. 2B. At 202 in FIG. 2A, an annotation schema is created in a first document 304, as illustrated in FIG. 2C. For example, the first document 304 defines a schema for providing a sequence or an order for rendering a collection of data, such as the “CustomerType” defined in the first XML document 302. At 204, at least a portion of the schema declared in the original document 302 is identified in the annotation schema (e.g., the schema in the first document 304 shown in FIG. 2C). For example, the first document 304 identifies or declares characteristics of the schema, such as the type or element (e.g., xs:string for “string” data type) to be used in the schema. In one embodiment, a qualified name (QName) of the schema types or elements is identified and stored in the annotation schema.

At 206, additional usage properties in the annotation schema in the first document 304 are declared for the identified portion of the schema in the original document 302. The additional usage properties provide additional utilities of the identified portion of the schema in the original document 302. For example, the schema in the first document 304 provides the additional usage, such as providing in what sequence or order does the “string” data type is to be rendered. In alternative embodiments, other uses, such as a “is-a” or “has-a” relationship between two schemas, may be defined. At 208, the additional usage properties are mapped to the identified portion of the schema in the original document 302. For example, the schema in the first document 304 is associated with the schema in the first document 304 so that the data instances derived from each schema may be properly referenced. In one embodiment, a mapping schema is generated so that the schema in the first document 304 may properly identify a target or an identified type or element in the original document 302. For example, the following illustrates an exemplary and simplified mapping XML schema:

```
<xs:element name=“OutOfLineAnnotation”>
  <xs:complexType>
    <xs:sequence>
      <xs:element name=“ParametricMetadata” type=“xs:anyType”/>
      <xs:element name=“Target” type=“xs:QName”/>
    </xs:sequence>
  </xs:complexType>
</xs:element>
```

At 210, a second document 306 is generated for specifying annotation data based on the defined annotation schema in the first document 304. For example, the second document 306 includes annotation data exemplified by a schema that declares “CustomerAccountNumber” data type be provided in an ascending sequence or order. In another embodiment, the second document 306 may include another schema that declares the same “CustomerAccountNumber” be provided in a descending sequence or order. As such, one or more third documents may be generated which include schemas relating to the schema in the original document 302 without altering or modifying the schema in an XML document.

In an alternative embodiment, the schema in the first document 304 may be associated with more than one original schema, such as the schema in the original document 302. For example, the schema in the first document 304 may declare multiple inheritances from other schemas using the following example:

```
        <xs:complexType name=“MultipleBaseTypes”>
          <xs:sequence>
            <xs:element name=“BaseTypeName” type=“xs:QName”
maxOccurs=“unbounded”/>
          </xs:sequence>
        </xs:complexType>
        <xs:complexType name=“DerivedType”>
          <xs:annotation>
            <xs:appInfo>
              <MultipleBaseTypes>
                <BaseTypeName>BaseType1</BaseTypeName>
                <BaseTypeName>BaseType2</BaseTypeName>
              </MultipleBaseTypes>
            </xs:appInfo>
          </xs:annotation>
          <xs:sequence>
            <!-- additional elements here... -->
          </xs:sequence>
        </xs:complexType>
```

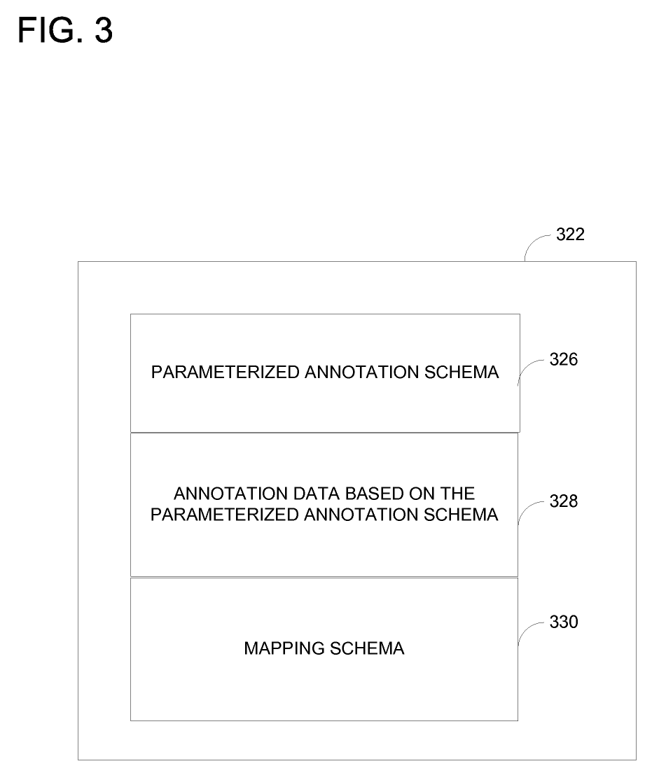

FIG. 3 is a block diagram illustrating a data structure 322 for storing data fields for associating one schema in one XML document with another schema in another XML document according to an embodiment of the invention. The data structure 322 includes a first data 326 for storing a parameterized annotation schema in a third document, such as the third document 326. The parameterized annotation schema defines usage properties associated with an XML schema type or element in the original document 302. For example, the first data field 326 may store the schema in the second document 306. The data structure 322 also includes a second data field 328 for storing annotation data based on the parameterized annotation schema stored in the first data field in a second document (e.g., document 304). The stored annotation data applies usages other than usages associated with the XML schema type or element in the first document according to the defined usage properties in the first data field 326. For example, the XML schema in the original document 302 may not provide a particular usage property, such as a subset relationship with another schema. The first data field 326 defines additional usage properties for such subset relationship, and the second data field 328 includes the annotation data that applies such subset relationship so that the XML schema in the original document 302 may be re-used while its usage has expanded to include the subset relationship usage with another schema.

The data structure 322 also includes a third data field 330 for storing a mapping schema for mapping the parameterized annotation schema in the first data field to the XML schema type or element of the first document. As described above, the mapping schema may properly identify a target or an identified type or element in the first data field 326 in the original document 302.

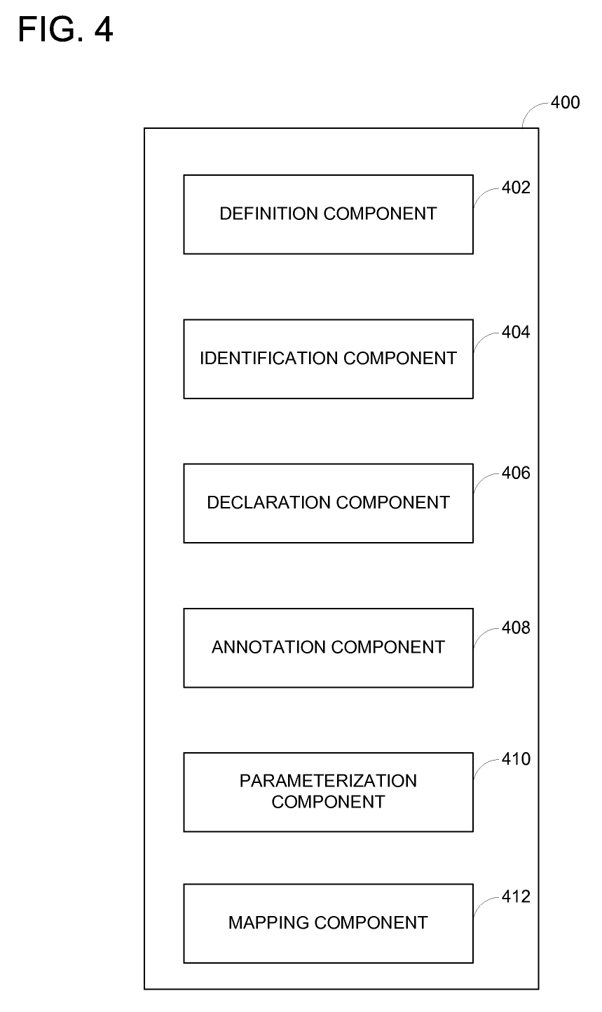

FIG. 4 is a diagram illustrating an exemplary computer-readable medium 400 on which aspects of the invention may be stored. For example, the computer-readable medium 400 may include one or more computer-executable components for associating schema elements or types declared in a schema in a first XML document with elements declared in a third XML document. In one embodiment, the computer-executable components include codes, routines, executable instructions or the like to be processed by a processor (not shown). In another embodiment, the computer-executable components may be embodied in software or application programs. In yet another alternative embodiment, the computer-executable components may be embodied in one or more computer-readable media being coupled by a communications network, either wired or wirelessly, between one another.

The computer-readable medium 400 includes a definition component 402 for defining an annotation schema in a second document. The computer-readable medium 400 also includes an identification component 404 for identifying at least a portion of the schema declared in the first document in the annotation schema of the second document. A declaration component 406 is also included in the computer-readable medium 400 for declaring usage properties in the annotation schema for the identified portion of the schema in the original document 302. The declared usage properties provide additional utilities of the identified portion of the schema. An annotation component 408 maps the usage properties to the identified portion of the schema in the original document. The computer-readable medium 400 further includes a parameterization component 410 for specifying annotation data in a third document based on the defined annotation schema in the second document. The specified annotation applies usages of the schema elements or types in the first document according to the usage properties declared in the second document.

In a further alternative embodiment, the computer-readable medium 400 includes a mapping component 412 for defining a mapping schema for mapping the annotation schema in the second document to the schema types or elements of the first document.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A computer-readable medium having a data structure stored thereon for associating elements across extensible markup language (XML) documents, said data structure comprising:
a first data field for storing a parameterized annotation schema in a first document, said parameterized annotation schema defining usage properties associated with an XML schema characteristics in an original document; and
a second data field for storing annotation data based on the parameterized annotation schema stored in the first data field in a second document, said stored annotation data apply usages other than usages associated with the XML schema characteristics in the original document according to the defined usage properties in the first data field.

2. The computer-readable medium of claim 1, further includes a third data field storing a mapping schema for mapping the parameterized annotation schema in the first data field to the XML schema characteristics of the original document.

3. The computer-readable medium of claim 2, wherein the first data field includes a reference in the parameterized annotation schema for identifying the XML schema characteristics in the first document according to the mapping schema.

4. The computer-readable medium of claim 1, wherein the parameterized annotation schema stored in the first data field comprises a schema defining usage properties associated with a plurality of XML schema characteristics in a document other than the original document.

5. The computer-readable media of claim 4, wherein the parameterized annotation schema stored in the first data field establishes multiple inheritance relationships with the plurality of XML schemas characteristics based on the mapping schema and the defined usage properties.

6. The computer-readable medium of claim 1, the first data field includes data representing a qualified name (QName) of the XML schema characteristics.

7. A method for associating schema characteristics declared in a schema in an original XML document with schema characteristics declared in another XML document, said method comprising:
defining an annotation schema in a first document;
identifying at least a portion of the schema declared in the original document in the annotation schema of the first document;
declaring usage properties in the annotation schema for the identified portion of the schema in the original document, said declared usage properties providing additional utilities of the identified portion of the schema;
mapping the usage properties to the identified portion of the schema in the original document; and
specifying annotation data in a second document based on the defined annotation schema in the first document, said specified annotation applying usages of the schema characteristics in the original document according to the usage properties declared in the first document.

8. The method of claim 7, further comprising defining a mapping schema for mapping the annotation schema in the first document to the schema characteristics of the original document.

9. The method of claim 8, wherein defining the mapping schema comprises including a reference in the annotation schema for identifying the schema characteristics in the original document according to the mapping schema.

10. The method of claim 7, wherein declaring the usage properties in the annotation schema further comprises declaring usage properties associated with a plurality of XML schema characteristics in a document other than the original document.

11. The method of claim 10, further comprising establishing multiple inheritance relationships with the plurality of XML schemas characteristics based on the mapping schema and the declared usage properties.

12. The method of claim 7, wherein identifying comprises identifying the qualified name (QName) of the schema types or elements.

13. The method of claim 7, wherein one or more computer-readable media have computer-executable instructions for performing the method of claim 7.

14. One or more computer-readable media having computer-executable components for associating schema characteristics declared in a schema in an original XML document with elements declared in another XML document, said computer-executable components comprising:
a definition component for defining an annotation schema in a first document;
an identification component for identifying at least a portion of the schema declared in an original document in the annotation schema of the first document;
a declaration component for declaring usage properties in the annotation schema for the identified portion of the schema in the original document, said declared usage properties providing additional utilities of the identified portion of the schema;
an annotation component for mapping the usage properties to the identified portion of the schema in the original document; and
a parameterization component for specifying annotation data in a second document based on the defined annotation schema in the first document, said specified annotation applying usages of the schema characteristics in the original document according to the usage properties declared in the first document.

15. The computer-readable media of claim 14, further comprising a mapping component for defining a mapping schema for mapping the annotation schema in the first document to the schema characteristics of the original document.

16. The computer-readable media of claim 15, wherein the mapping component includes a reference in the annotation schema for identifying the schema characteristics in the original document according to the mapping schema.

17. The computer-readable media of claim 14, wherein the declaration component declares the usage properties associated with a plurality of XML schema characteristics in a document other than the original document.

18. The computer-readable media of claim 17, wherein the declaration component further comprises establishing multiple inheritance relationships with the plurality of XML schemas characteristics based on the mapping schema and the declared usage properties.

19. The computer-readable media of claim 17, wherein the identification component identifies the qualified name (QName) of the schema types or elements.
